(19) United States
(12) Patent Application Publication
(10) Pub. No.: US 2017/0138500 A1
(43) Pub. Date: May 18, 2017

(54) Bottom Outlet Valve Protector

(71) Applicant: UTLX Manufacturing LLC, Alexandria, LA (US)

(72) Inventor: Jarred Ryan Beaubouef, Deville, LA (US)

(21) Appl. No.: 15/353,446

(22) Filed: Nov. 16, 2016

Related U.S. Application Data
(60) Provisional application No. 62/256,418, filed on Nov. 17, 2015.

(51) Int. Cl. F16K 27/12

(52) U.S. Cl. CPC F16K 27/12; B61D 5/00

(57) ABSTRACT

A cover comprising a base wall having a conical shape and a substantially cylindrically shaped side wall shaped to fit onto a bottom outlet valve of a railroad tank car. The cover may be installed to protect the bottom outlet valve during the manufacturing as well as repair process by keeping any debris from falling on the valve. The cover may have at least one aperture extending through the cover to allow for the tank to be pressure tested during repair.

### CROSS-REFERENCE TO RELATED APPLICATION

This application claims priority to U.S. Provisional Application No. 62/256,418, filed Nov. 17, 2015. This application is incorporated by reference in its entirety.

### TECHNICAL FIELD

Aspects of this disclosure relate to a cover for use in railroad tank cars to protect the bottom outlet valve during manufacturing and repair.

### BACKGROUND

Many railroad tank cars have bottom outlet valves (BOVs) to allow for a simple means of unloading the payload being transported, most of which are liquids. The BOVs are usually ball valves located at the bottom of the tank of the railroad tank car. The BOV is in a closed position to load the payload into the tank of the railroad tank car, and is in an open position to unload the payload through the BOV.

Tank cars often need repairs and/or maintenance because of the wear and tear that accumulates from normal use. Tank cars may be shipped to repair shops for maintenance such as repairing the lining within the tank car. During the repair process, debris and other materials may fall into the BOV and potentially cause damage to the BOV. Since any damage to the BOV could potentially shorten the life of the BOV or cause a leak from the BOV, a need exists for a means to protect the BOV while the repair process is ongoing. Thus, a device that protects the BOV can reduce the amount of wear and damage to a BOV that occurs when the tank car is being repaired, while still allowing the tank car and BOV to be pressurized and leak checked during the repair process.

Additionally, when new tank cars are being fabricated, they are often built at one facility and may be transported to a different facility to have the lining installed inside the tank car. Since the BOV is typically installed at the time when the tank car is manufactured, a means of protecting the BOV from damage during the entire manufacturing process, from car fabrication to lining installation, is desired. A device that protects the BOV can reduce the amount of wear and damage to a BOV that occurs when the tank car is being manufactured, while still allowing the tank car and BOV to be pressurized and leak checked during the entire manufacturing process.

### BRIEF SUMMARY

Aspects of this disclosure relate to a cover for a bottom outlet valve of a railroad tank car that comprises a first end having base wall, a second end opposite the first end having an angled flange and an opening for a cavity, a generally cylindrical side wall positioned between the first end and second end, a rounded transition surface connecting the base wall and the side wall; and at least one aperture extending through an exterior surface into the cavity. The cover may have a portion made of a non-metallic material and have a weight within a range of 0.10 pounds and 0.50 pounds. An obtuse angle may be formed between a portion of the base wall and the side wall is an obtuse angle. The at least one aperture may be a cylindrical hole, which may have a diameter within a range of 0.06 inches and 0.375 inches. Also, the at least one aperture may comprise four apertures and that the at least one aperture may be positioned on the transition surface. The angled flange may form a planar surface.

Additional aspects of this disclosure relate to a cover for a bottom outlet valve of a railroad tank car that comprises a first end having base wall, a second end opposite the first end having an angled flange and an opening for a cavity, a generally cylindrical side wall positioned between the first and second ends, a plurality of apertures extending through an exterior surface into the cavity, and where an angle between a portion of the base wall and the side wall is an obtuse angle. The plurality of apertures may be cylindrical holes, where the cylindrical holes may have a diameter within a range of 0.06 inches and 0.375 inches. The cover may have a portion made of a polymeric material and may have a weight within a range of 0.10 pounds and 0.50 pounds. In addition, the angled flange may have a diameter within a range of 4.0 inches and 10.0 inches. Also, the wall thickness of the cover may be constant.

Still other aspects of this disclosure relate to a cover for a bottom outlet valve of a railroad tank car that comprises a first end having base wall, a second end opposite the first end having an angled flange and an opening for a cavity, a generally cylindrical side wall positioned between the first and second ends having a diameter between 6.25 and 7.0 inches, at least one cylindrical hole extending through an exterior surface into the cavity; and where an angle between a portion of the base wall and the side wall is an obtuse angle.

### BRIEF DESCRIPTION OF THE DRAWINGS

The present invention is illustrated by way of example and not limited in the accompanying figures in which like reference numerals indicate similar elements and in which:

FIG. 1 depicts a perspective view of an example BOV protector, according to one or more aspects described herein.

FIG. 2 shows a side view of an example railroad tank car with a bottom outlet valve.

FIG. 3 depicts a partial cross-section of the example BOV protector of FIG. 1 installed over a bottom outlet valve, according to one or more aspects described herein.

FIG. 4 depicts a simplified perspective view cross-section of the example BOV protector of FIG. 1 installed over a bottom outlet valve with a portion removed to show detail, according to one or more aspects described herein.

FIG. 5 depicts a top view of the example BOV protector of FIG. 1, according to one or more aspects described herein.

FIG. 6 depicts a side view of the example BOV protector of FIG. 1, according to one or more aspects described herein.

FIG. 7 depicts a cross-sectional view of the example BOV protector from FIG. 4.

FIG. 8 depicts a perspective view of an alternate embodiment of an example BOV protector, according to one or more aspects described herein.

FIG. 9 depicts a perspective view of an alternate embodiment of an example BOV protector, according to one or more aspects described herein.

Further, it is to be understood that the drawings may represent the scale of different components of one single embodiment; however, the disclosed embodiments are not limited to that particular scale.

### DETAILED DESCRIPTION

Aspects of this disclosure relate to a BOV protector or cover that may be temporarily installed during either the manufacturing or the repair process to keep debris and other materials from falling into or onto the BOV while any work is being done on the tank car. The BOV protector may comprise a base wall, a side wall, and a flange. Further, the BOV protector may have a plurality of apertures positioned on the base wall to allow for the tank car to be pressurized during either the manufacturing or repair process. The BOV protector may be releasable and easily removed from the tank car before the final assembly of the BOV.

In the following description of various example structures according to the invention, reference is made to the accompanying drawings, which form a part hereof, and in which are shown by way of illustration various example devices, systems, and environments in which aspects of the invention may be practiced. It is to be understood that other specific arrangements of parts, example devices, systems, and environments may be utilized and structural and functional modifications may be made without departing from the scope of the present invention. Also, while the terms “top,” “bottom,” “front,” “back,” “side,” “rear,” and the like may be used in this specification to describe various example features and elements of the invention, these terms are used herein as a matter of convenience, e.g., based on the example orientations shown in the figures or the orientation during typical use. Nothing in this specification should be construed as requiring a specific three dimensional orientation of structures in order to fall within the scope of this invention. Also, the reader is advised that the attached drawings are not necessarily drawn to scale.

The following terms are used in this specification, and unless otherwise noted or clear from the context, these terms have the meanings provided below.

“Plurality” indicates any number greater than one, either disjunctively or conjunctively, as necessary, up to an infinite number.

“Substantially constant” when referring to a dimension means that a value is approximately the same and varies no more than +/−5%.

“Integral joining technique” or means a technique for joining two pieces so that the two pieces effectively become a single, integral piece, including, but not limited to, irreversible joining techniques, such as welding, brazing, adhesively joining, cementing, or the like, where separation of the joined pieces cannot be accomplished without structural damage thereto. Pieces joined with such a technique are described as “integrally joined.”

In the following description of the various embodiments, reference is made to the accompanying drawings, which form a part hereof, and in which is shown, by way of illustration, various embodiments in which aspects of the disclosure may be practiced. It is to be understood that other embodiments may be utilized and structural and functional modifications may be made without departing from the scope and spirit of the present disclosure

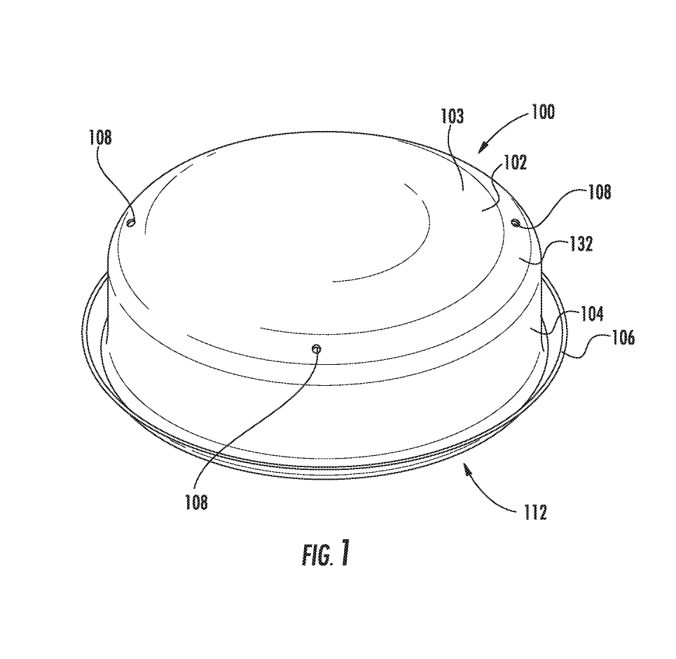

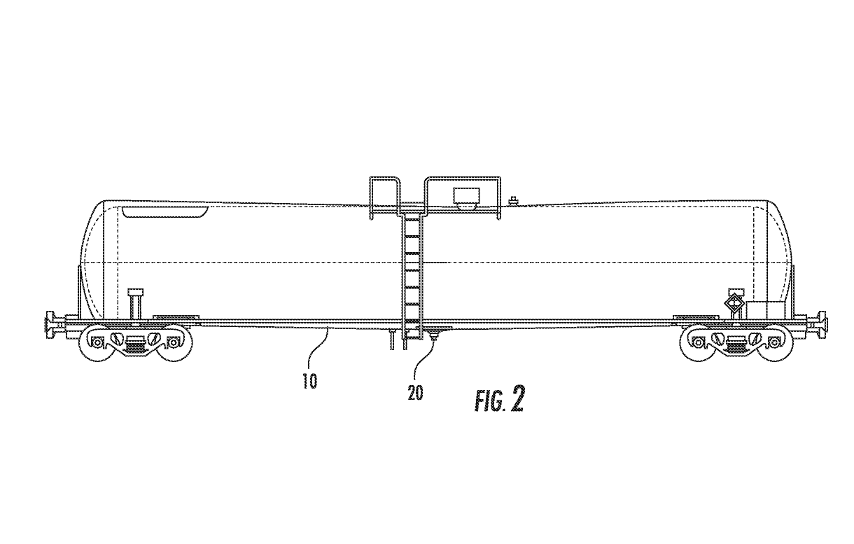

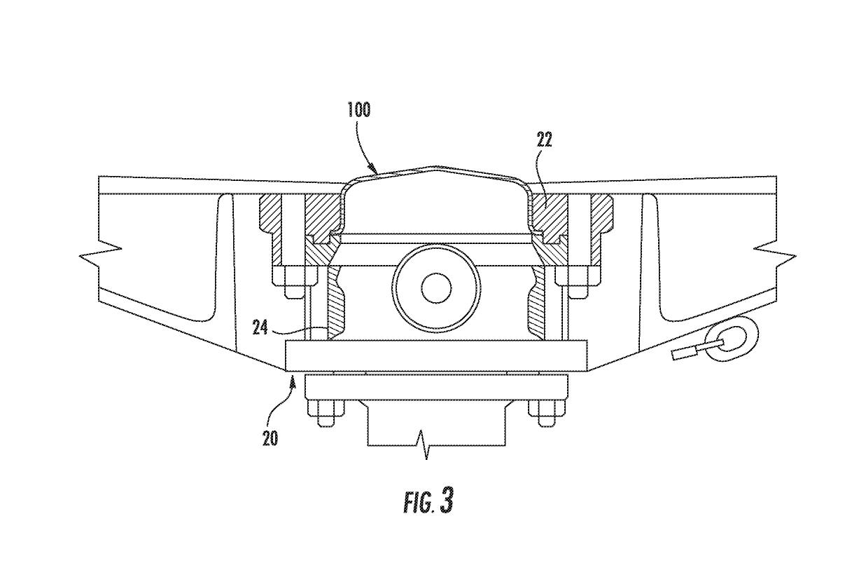

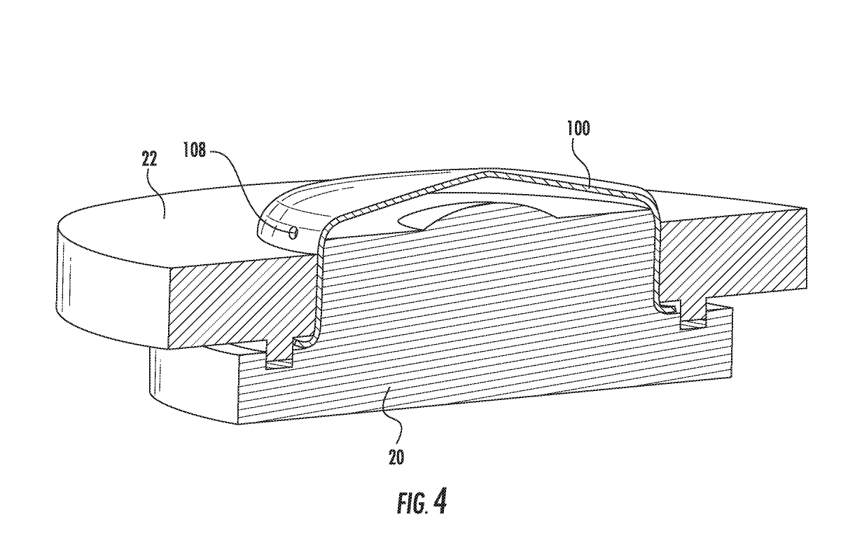

FIG. 1 depicts an isometric view of an example BOV protector or cover 100, according to one or more aspects described herein. FIG. 2 shows an example railroad tank car 10 and the location of a bottom outlet valve (BOV) 20 proximate the center of the tank car 10. Additionally, FIGS. 3 and 4 show views of an example BOV protector 100 of FIG. 1 installed over the inlet of the BOV 20. As illustrated in FIGS. 3 and 4, the BOV 20 with the BOV protector 100 may be installed into an outlet saddle 22 of the tank car 10. Additionally, as illustrated in FIGS. 3 and 4, the BOV 20 may also include a ball valve assembly 24 which may be closed when the tank car 10 is being loaded or opened to empty the tank car 10.

As an example use, the BOV protector 100 may be a thin-walled, somewhat hemispherical-shaped, polymer protector that may fit securely over the inlet of the BOV 20 while still providing sufficient space for the ball of the valve assembly 24 to actuate. The BOV protector 100 may be clamped into position when installed between the outlet saddle 22 and BOV 20 while still allowing proper gasket installation and pressure testing of the system. The BOV protector 100 acts to protect the BOV 20 during the railroad tank car manufacturing or repair process. When the BOV 20 is initially installed in a tank car 10 or is brought in for repairs, the BOV protector 100 may be installed over the inlet of the BOV 20 of the tank car 10. The BOV protector 100 may be mounted between the outlet saddle 22 of the tank car 10 and the ball valve assembly 24 of the BOV 20. Next, the tank car 10 may be pressure tested at an accepted pressure (such as 30 psi) with a pressure test, for example a soap leak test or other pressure tests known and used in the field. After passing the pressure test, the tank car 10 may be shipped to a lining shop where the BOV 20, the BOV protector 100, and other fittings are removed from the tank car 10 and a lining is sprayed to the inside of the tank car 10. The BOV 20 may then be reinstalled without the BOV protector 100, and the BOV protector 100 discarded.

FIGS. 1 and 5-7 illustrate an example BOV protector 100. As illustrated in FIGS. 1 and 5-7, the BOV protector 100 may comprise a base wall 102, a flange 106 opposite the base wall 102, and a side wall 104 between the base wall 102 and the flange 106. The side wall 104 may be substantially cylindrical. The base wall 102 may be directly connected to the side wall 104 or may be connected using a transition surface 132 having a large exterior radius 130 to avoid having a sharp corner at the juncture. The BOV protector 100 may have a plurality of apertures 108 extending through the transition surface 132 or base wall 102 to enable the tank car 10 to be pressurized to check for any leaks while the BOV protector 100 is positioned over the BOV 20.

The base wall 102 may provide a surface to keep any debris out of the BOV 20 that may fall onto the BOV 20 during either the manufacturing or repair/maintenance process. The flange 106 may provide a surface to secure the BOV protector 100 above the BOV 20.

The BOV protector 100 may be made of a non-metallic material, such as a polymeric or composite material. The non-metallic material may have a low density of between a range of 0.03 to 0.08 pounds per cubic inch (0.9 and 2.2 grams per cubic centimeter) or between a range of 0.035 and 0.055 pounds per cubic inch (0.95 and 1.5 grams per cubic centimeter). As a result of using the low density material, the BOV protector 100 may have an overall weight approximately 0.25 pounds, or within a range of 0.15 pounds and 0.35 pounds, or within a range of 0.10 pounds and 0.50 pounds, or may weigh as much as 1.0 pound.

The non-metallic material of the BOV protector 100 may be chemical resistant. Alternatively, the BOV protector 100 may be coated with a chemical resistant material. Additionally, the non-metallic material or the coating may have a tinted color to be easily visible as a reminder to an end user to remove it before the final assembly is complete. For example, the BOV protector 100 may be a blue color such as the Pantone Matching System (PMS) color 286.

Additionally, the BOV protector 100 may be made of a unitary construction. For example, the BOV protector 100 may be made by an injection molding or forming process. Alternatively, the BOV protector 100 may be made of a plurality of pieces that are connected using an integral joining technique.

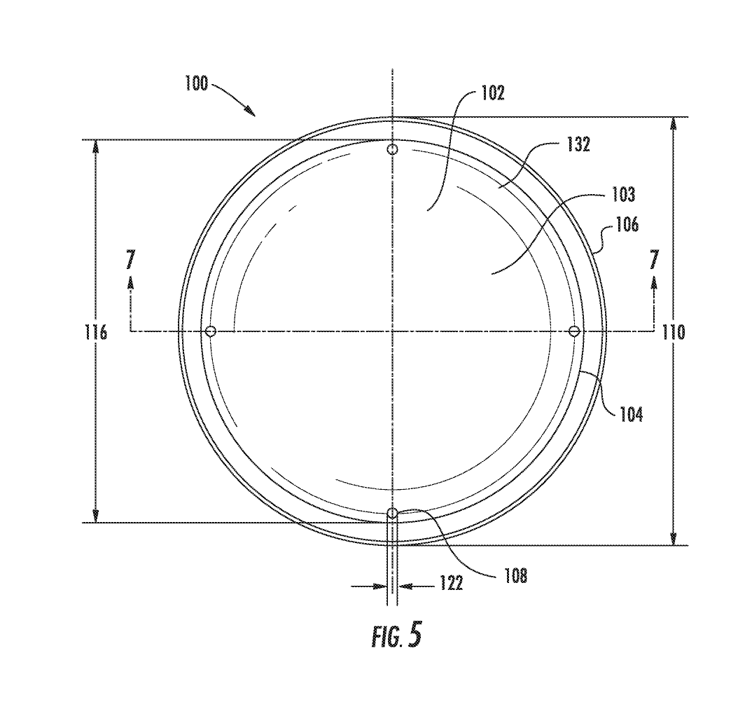

FIG. 5 shows a top view of the example BOV protector 100. The BOV protector 100 may have a generally circular shape when viewed from the top. Other shapes for the BOV protector 100 may be utilized without departing from this invention. The BOV protector 100 may have a flange 106 that extends beyond the side wall 104 at an acute angle to the side wall 104. The flange 106 may have a size defined by a diameter dimension 110 of approximately 7.375 inches or within a range between 7.25 inches and 7.5 inches, or within a range of 7.00 inches and 7.75 inches, or within a range of 4.0 inches and 10.0 inches, or any other dimensions to adequately cover the BOV 20. Further, the side wall 104 may have a diameter 116 of approximately 6.612 inches, or within a range between 6.50 inches and 6.75 inches, or within a range of 6.25 inches and 7.00 inches, or within a range of 4.0 inches and 10.0 inches, or any other dimensions to adequately cover the BOV 20.

The plurality of apertures 108 shown in FIGS. 1, 5 and 6 may extend through the transition surface. The plurality of apertures 108 may be located anywhere on the transition surface 132. Alternatively the plurality of apertures 108 may be located anywhere on the side wall 104. For example, the plurality of apertures 108 may be equally spaced along the transition surface 132 as shown in FIGS. 1, 5 and 6. As shown in the embodiment shown in FIGS. 1, 5, and 6, the BOV protector 100 may have four apertures 108 that are spaced approximately 90 degrees apart. The BOV protector 100 may have any number of equally spaced apertures 108, such as 2, 3, 5 or 6 apertures 108. Alternatively, the plurality of apertures 108 may be unequally spaced. The aperture 108 may be located proximate a midpoint of the transition surface 132 between the base wall 102 and the side wall 104, or where the side wall 104 meets the transition surface 132. The plurality of apertures 108 may be cylindrical holes having a diameter 122 of approximately 0.125 inches, or within a range of 0.06 inches and 0.375 inches, or within a range of 0.03 inches and 0.50 inches, or within a range of 0.03 inches to 1.0 inches. The plurality of apertures 108 may be other shapes and sizes without departing from this invention, such that the plurality of apertures 108 adequately allow pressure testing of the tank car 10 and do not allow debris to fall onto the BOV 20. Additionally, the plurality of apertures 108 may be located at a height 140 defined from a center of an aperture 108 to the furthest extent of the flange 106. The height 140 may be approximately 1.60 inches, or within a range of 1.45 inches to 1.75 inches, or within a range of 1 inch to 3 inches.

An exterior surface 103 of the base wall 102 may have an indicator or warning label embossed or molded within on it as a reminder to the end user to remove the BOV protector 100 prior to the final assembly of the BOV 20.

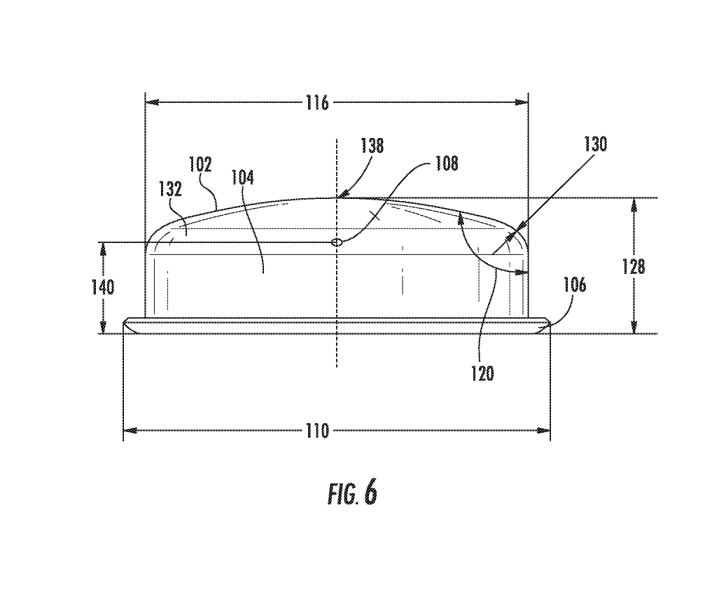

FIG. 6 shows a side view of the example BOV protector 100. The BOV protector 100 has a base wall 102 that is conically shaped such that the base wall 102 and side wall 104 form an obtuse angle 120. The angle 120 may be approximately 100 degrees or may be within a range of 91 degrees to 120 degrees, or up to as much as approximately 150 degrees. The base wall 102 may have a radius 138 at a center of the base wall 102. The radius 138 may be approximately 1 inch, or within a range of 0.25 inches to 3 inches. Additionally, the side wall 104 may be tapered such that the top of the side wall 104 may be smaller than the bottom of the side wall 104 near the flange 136. The BOV protector 100 may have an overall height 128 measured from the furthest extent of the exterior surface 103 of the base wall 102 to the furthest extent of the flange 106. The height 128 may be approximately 2.30 inches, or within a range of 2.20 inches and 2.40 inches, or within a range of 2.00 inches to 2.50 inches, or within a range of 1.5 inches to 4 inches, or within a range of 1.0 inches to 6.0 inches. As discussed previously, the base wall 102 may be directly connected to the side wall 104 or may be connected using a transition surface 132 having large exterior radius 130 to avoid having a sharp corner at the juncture. The exterior radius 130 may be approximately 0.575 inches, or within a range of 0.325 inches and 0.825 inches, or within a range of 0.25 inches to 1.5 inches.

The BOV protector 100 may have a wall thickness 114, which may be substantially constant. For example, the wall thickness 114 may be approximately 0.075 inches, or may be within a range of 0.060 inches and 0.090 inches, or may be within a range of 0.037 inches and 0.125 inches, up to as thick as 0.5 inches. Alternatively, the wall thickness 114 may have varying thicknesses throughout the BOV protector 100.

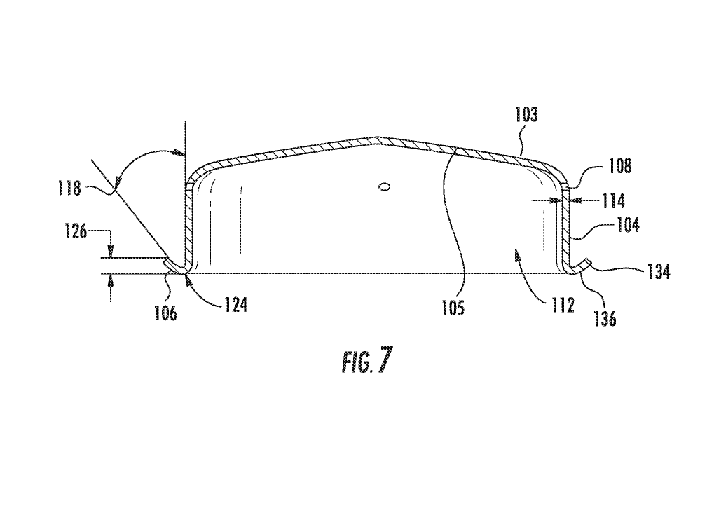

FIG. 7 shows a cross-sectional view of the BOV protector 100 illustrated in FIG. 5. As illustrated in FIG. 7, the BOV protector 100 may have a cavity 112 on the end opposite the base wall 102 open to and exposing an interior surface 105 of the base wall 102. The flange 106 may comprise a straight wall 134 that extends beyond the side wall 104 that is positioned at an acute angle 118 to the side wall 104 and a curved wall 136 connecting to the side wall 104 with a radius 124. The angle 118 between the straight wall 134 of the flange 106 and side wall 104 may be approximately 39 degrees, or may be within a range of 35 degrees to 45 degrees, or may be within a range of 25 degrees to 60 degrees. The exterior radius 124 of the curved wall 136 may be approximately 0.25 inches, or within a range between 0.125 inches and 0.375 inches, or may be within a range of 0.1 inches and 0.75 inches.

The flange 106 may have a height 126 defined as the maximum distance from the interior corner of the flange 106 to the inflection point of the curved wall 136. The flange 106 may create a planar surface or edge to allow the BOV protector 100 to contact the planar surface without creating any substantial gaps between the planar surface and the flange 106.

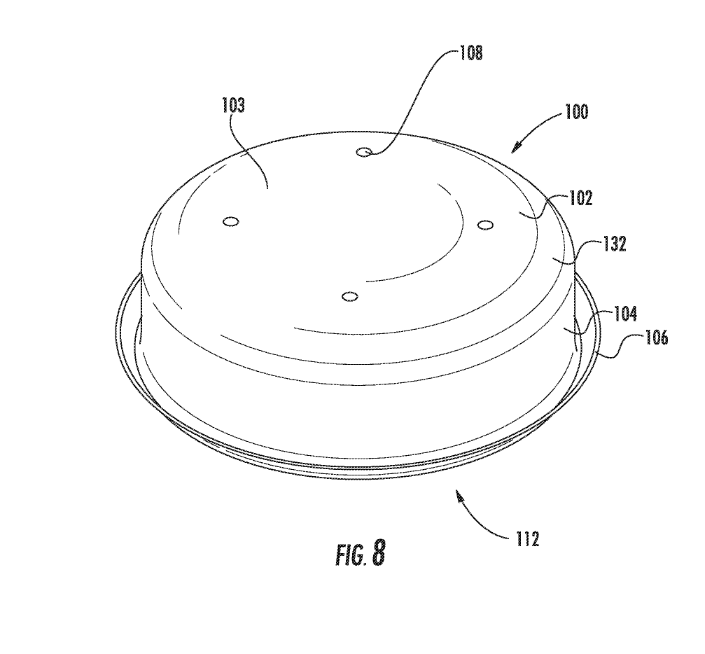

FIG. 8 illustrates an alternate embodiment of the BOV protector 100. Alternatively, the plurality of apertures 108 may be located through the base wall 102 or through the side wall 104. FIG. 8 shows an alternate embodiment of the BOV protector 100 having the plurality of apertures 108 located on the base wall 102. In these alternate embodiments, the plurality of apertures 108 may be located anywhere on the base wall 102.

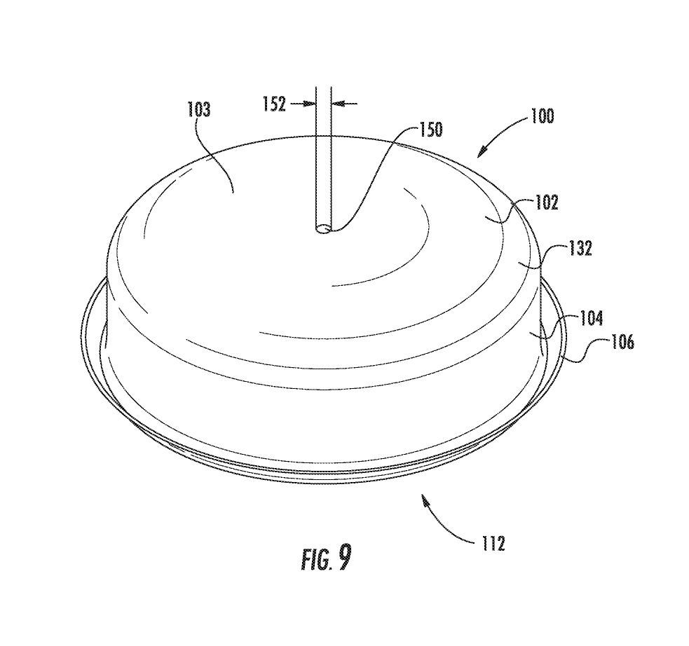

FIG. 9 illustrates another alternate embodiment of the BOV protector 100. As another alternate embodiment shown in FIG. 9 the BOV protector 100 may have a single aperture 150 located on the BOV protector 100 as shown in FIG. 9. The aperture 108 may be a single hole as shown in FIG. 9 that extends through the base wall 102. The aperture 150 may be located anywhere on the base wall 102 or the transition surface 132. For example, the aperture 150 may be located at the center of the base wall 102 as shown in FIG. 9, or the aperture 150 may be located anywhere on the base wall 102, or anywhere on the transition surface 132, or side wall 104. The aperture 150 may be a cylindrical hole having a diameter 152 of approximately 0.25 inches, or within a range of 0.1 inches and 0.375 inches, or within a range of 0.06 inches and 0.50 inches, or within a range of 0.03 to 1.0 inches. The aperture 150 may be a different shape and size without departing from this invention, such that the aperture 150 adequately allows pressure testing of the tank car 10 and does not allow debris to fall onto the BOV 20.

The present disclosure is disclosed above and in the accompanying drawings with reference to a variety of examples. The purpose served by the disclosure, however, is to provide examples of the various features and concepts related to the disclosure, not to limit the scope of the invention. One skilled in the relevant art will recognize that numerous variations and modifications may be made to the examples described above without departing from the scope of the present disclosure.

What is claimed is:

1. A cover for a bottom outlet valve of a railroad tank car, comprising:
a first end having base wall,
a second end opposite the first end having an angled flange and an opening for a cavity,
a generally cylindrical side wall positioned between the first end and the second end,
a rounded transition surface connecting the base wall and the side wall; and
at least one aperture extending through an exterior surface into the cavity.

2. The cover claim 1, wherein the cover has a portion made of a non-metallic material.

3. The cover of claim 1, wherein the cover has a weight within a range of 0.10 pounds and 0.50 pounds.

4. The cover of claim 1, wherein an angle between a portion of the base wall and the side wall is an obtuse angle.

5. The cover of claim 1, wherein the at least one aperture is a cylindrical hole.

6. The cover claim 5, wherein the cylindrical hole has a diameter within a range of 0.06 inches and 0.375 inches.

7. The cover of claim 1, wherein the at least one aperture comprises four apertures.

8. The cover of claim 1, wherein the at least one aperture is positioned on the transition surface.

9. The cover of claim 1, wherein the angled flange forms a planar surface.

10. A cover for a bottom outlet valve of a railroad tank car, comprising:
a first end having base wall,
a second end opposite the first end having an angled flange and an opening for a cavity,
a generally cylindrical side wall positioned between the first end and the second end,
a rounded transition surface connecting the base wall and the side wall;
a plurality of apertures extending through an exterior surface into the cavity; and
wherein an angle between a portion of the base wall and the side wall is an obtuse angle.

11. The cover of claim 10, wherein the plurality of apertures are cylindrical holes.

12. The cover of claim 11, wherein the cylindrical holes have a diameter within a range of 0.06 inches and 0.375 inches.

13. The cover of claim 10, wherein the angled flange has a diameter within a range of 4.0 inches and 10.0 inches.

14. The cover of claim 10, wherein the cover has a portion made of a polymeric material.

15. The cover of claim 10, wherein a wall thickness of the cover is constant.

16. The cover of claim 10, wherein the cover has a weight within a range of 0.10 pounds and 0.50 pounds.

17. A cover for a bottom outlet valve of a railroad tank car, comprising:
a first end having base wall,
a second end opposite the first end having an angled flange and an opening for a cavity,
a generally cylindrical side wall positioned between the first end and the second end having a diameter between 6.25 and 7.0 inches,
at least one aperture extending through an exterior surface into the cavity; and
wherein an angle between a portion of the base wall and the side wall is an obtuse angle.

18. The cover of claim 17, wherein the cover has a weight within a range of 0.10 pounds and 0.50 pounds.

19. The cover of claim 17, wherein the cover has a portion made of a non-metallic material.

20. The cover of claim 17, wherein a wall thickness of the cover is constant.
